(19) United States
(12) Patent Application Publication
(10) Pub. No.: US 2005/0249998 A1
(43) Pub. Date: Nov. 10, 2005

(54) Fuel cell with pre-shaped current collectors

(76) Inventors: Constantinos Minas, Slingerlands, NY (US); Robert S. Hirsch, Troy, NY (US)

Correspondence Address: CESARI AND MCKENNA, LLP, 88 BLACK FALCON AVENUE, BOSTON, MA, 02210, US

(21) Appl. No.: 10/840,831

(22) Filed: May 7, 2004

(51) Int. Cl. H01M 8/02; H01M 8/10; H01M 8/24

(52) U.S. Cl. 429/37; 429/66; 429/30

(57) ABSTRACT

The present invention discloses a process for manufacturing a fuel cell and an associated fuel cell array that includes novel pre-shaped current collectors and conforming compression plates. The current collectors are pre-shaped to counteract any deflection of the fuel cell after compression is released during manufacture. The pre-shaped current collectors may bend outwards by the same amount as previously, however, the overall compression relaxation may be much lower because the pre-shaped current collectors are bending back into the flat position, as opposed to away from it. Also provided with the present invention are associated mold plates that induce the desired pre-shaping to the current collectors.

### BACKGROUND OF THE INVENTION

1. Field of the Invention

This invention relates generally to fuel cells, and more particularly, to the manufacture of such fuel cells.

2. Background Information

Fuel cells are devices in which electrochemical reactions are used to generate electricity. A variety of materials may be suited for use as a fuel depending upon the nature of the fuel cell. Organic materials, such as methanol or natural gas, are attractive fuel choices due to their high specific energy.

Fuel cell systems may be divided into “reformer-based” systems (i.e., those in which the fuel is processed in some fashion to extract hydrogen from the fuel before it is introduced into the fuel cell) or “direct oxidation” systems in which the fuel is fed directly into the cell without the need for separate internal or external processing. Most is currently available fuel cells are reformer-based fuel cell systems. However, because fuel processing is complex, and requires expensive components, which occupy comparatively significant volume, the use of reformer based systems is presently limited to comparatively large, high power applications.

Direct oxidation fuel cell systems may be better suited for a number of applications in smaller mobile devices (e.g., mobile phones, handheld and laptop computers), as well as in some larger scale applications. In fuel cells of interest here, a carbonaceous fuel (including, but not limited to, liquid methanol, or an aqueous methanol solution) is applied to the anode face of a membrane electrode assembly (MEA). The MEA contains a protonically conductive, but electronically non-conductive membrane (PCM). Typically, a catalyst, which enables direct oxidation of the fuel on the anode aspect of the PCM, is disposed on the surface of the PCM (or is otherwise present in the anode chamber of the fuel cell). In the fuel oxidation process at the anode, the products are protons, electrons and carbon dioxide. Protons (from hydrogen in the fuel and water molecules involved in the anodic reaction) are separated from the electrons. The protons migrate through the PCM, which is impermeable to the electrons. The electrons travel through an external circuit, which includes the load, and are united with the protons and oxygen molecules in the cathodic reaction, thus providing electrical power from the fuel cell.

One example of a direct oxidation fuel cell system is a direct methanol fuel cell system or DMFC system. In a DMFC system, a mixture comprised predominantly of methanol and water is used as fuel (the “fuel mixture”), and oxygen, preferably from ambient air, is used as the oxidizing agent. The fundamental reactions are the anodic oxidation of the methanol and water in the fuel mixture into CO₂, protons, and electrons; and the cathodic combination of protons, electrons and oxygen into water. The overall reaction may be limited by the failure of either of these reactions to proceed at an acceptable rate (more specifically, slow oxidation of the fuel mixture will limit the cathodic generation of water, and vice versa).

Direct methanol fuel cells are being developed towards commercial production for use in portable electronic devices. Thus, the DMFC system, including the fuel cell and the other components should be fabricated using materials and processes that are not only compatible with appropriate form factors, but which are also cost effective. Furthermore, the manufacturing process associated with a given system should not be prohibitive in terms of associated labor or manufacturing cost or difficulty.

Typical DMFC systems include a fuel source, fluid and effluent management and air management systems, and a direct oxidation fuel cell (“fuel cell”). The fuel cell typically consists of a housing, hardware for current collection and fuel and air distribution, and a membrane electrode assembly (“MEA”) disposed within the housing.

A typical MEA includes a centrally disposed, protonically conductive, electronically non-conductive membrane (“PCM”). One example of a commercially available PCM is NAFION® a registered trademark of E.I. Dupont de Nemours and Company, a cation exchange membrane comprised of polyperflourosulfonic acid, in a variety of thicknesses and equivalent weights. The PCM is typically coated on each face with an electrocatalyst such as platinum, or platinum/ruthenium mixtures or alloy particles. On either face of the catalyst coated PCM, the electrode assembly typically includes a diffusion layer. The diffusion layer on the anode side is employed to evenly distribute the liquid fuel mixture across the anode face of the PCM, while allowing the gaseous product of the reaction, typically carbon dioxide, to move away from the anode face of the PCM. In the case of the cathode side, a diffusion layer is used to achieve a fast supply and even distribution of gaseous oxygen across the cathode face of the PCM, while minimizing or eliminating the collection of liquid, typically water, on the cathode aspect of the PCM. Each of the anode and cathode diffusion layers also assist in the collection and conduction of electric current from the catalyzed PCM.

As noted, the MEA is typically comprised of a centrally disposed PCM to which an appropriate electrocatalyst has been applied or otherwise is in intimate contact with the PCM. Typically a diffusion layer is adjacent to each of the anode and cathode diffusion layer to allow reactants to reach the active catalyst sites, and allowing product of the reaction to be transported away from each of the anode and cathode aspects of the PCM. Gaskets are often used to maintain the catalytic layers and the diffusion layers in place. Current collectors are used within the assembly to provide an electron path to the load. These current collectors are made of a conductive material that is preferably non-reactive with methanol, and must allow for the transport of gas and liquid. Typically this can be achieved by using an open metal structure, which can be either coated or plated to enhance conductivity or to further protect the current collectors from adverse effects of the methanol and fuel cell, such as oxidation.

Generally, the entire MEA is placed into a frame structure including current collectors that both compresses the MEA and provides an electron path. Although this can provide some dimensional stability, the greater the compression that is required, the more mechanical components (i.e., screws, etc.) must be employed to assure adequate pressure. Those skilled in the art will recognize that sealing and application of significant pressure can be accomplished in various ways, typically utilizing mechanical fasteners such as screws, nuts, welds, pins, clips, and the like.

One example of a process for manufacturing a fuel cell and an associated fuel cell array is described in commonly-owned U.S. patent application Ser. No.: 10/650,424, filed on Aug. 28, 2003 by Fannon et al. for a METHOD OF MANUFACTURING A FUEL CELL ARRAY AND A RELATED ARRAY, which is presently incorporated herein by reference. This process includes compressing the fuel cell components and creating a frame about the components by injecting a plastic molding around the fuel cell. Once the injected plastic molded frame is set, the fuel cell frame holds the components of the cell in compression without the need for screws or nuts.

In more detail, prior to the injection molding process of a fuel cell, compression is applied to the assembly by applying a predetermined surface pressure (design pressure) with compression plates. This pre-molding compression is applied in order to reduce the contact resistance of the current collectors. After the plastic is injected and the assembly becomes an integrated structure, the surface pressure is released. Since the current collector is only held by the plastic frame at the perimeter, it can bend outward to a three-dimensional shape that is convex about the two in-plane axes, with the maximum deflection occurring at the center. As a consequence, a part or all of the applied compression at the center region is relaxed which results in increased contact resistance of the current collector. A small additional relaxation may also occur at the boundaries caused by the stretching (creeping) of the plastic frame. The maximum deflection of the current collector is the design driver and depends on the current collector geometry and flexural rigidity.

One solution to these problems is to add a “compliance layer” as described in commonly-owned U.S. patent application Ser. No.: 10/792,024, filed on Mar. 3, 2004 by Minas et al. for a FUEL CELL WITH COMPLIANCE LAYER, which is presently incorporated herein by reference. The compliance layer is inserted between the MEA and the current collectors, and is used to reduce the compressive stiffness of the fuel cell and maintain acceptable contact resistance between the MEA and the current collectors. In essence, the compliance layer acts to maintain a pressure within the manufactured fuel cell, and fills any gaps created by the outward bending of the current collectors. Use of the compliance layer, however, adds another manufacturing material to the layers of the fuel cell assembly, and in some situations, may not adequately prevent the assembly from bending outwards.

There remains a need, therefore, for a process of manufacturing and assembling a fuel cell or a fuel cell array, which results in maintaining a desired contact resistance of the current collector and the MEA, while maintaining a uniformity of fuel cell assembly dimensions and internal compression.

It is thus an object of the present invention to provide a process of manufacturing and assembling a fuel cell or a fuel cell array, which results in maintaining a desired contact resistance of the current collector, with a substantial uniformity of fuel cell assembly dimensions and internal compression. It is yet a further object of the invention to provide a fuel cell that has been produced by such processes.

### SUMMARY OF THE INVENTION

In brief summary, the present invention is a pre-shaped current collector and conforming compression plate, and a process for manufacturing a fuel cell and an associated fuel cell array that includes the novel current collectors. The pre-compression shape is designed in such a manner that post-compression relaxation causes the collector to relax to the desired position. In other words, the pre-compression shape is designed to anticipate and counteract the post-compression relaxation. Specifically, during manufacture, variable in-plane compression is applied to the fuel cell, and a frame is molded around the edges of the fuel cell to maintain the compression. After the frame is molded and the pressure is released, the pre-shaped current collectors deflect away from the membrane electrode assembly (MEA) to substantially the same degree as in presently known fuel cells. Although the displacement from this deflection is substantially the same, the overall compression relaxation is much lower because the pre-shaped current collectors are bending back to a parallel plane relative to the MEA, as opposed to flexing away from it in a convex manner. The pre-shaped current collectors may also increase creep tolerance of the fuel cell by preserving a pressure and connectivity of the fuel cell in the event the frame stretches after manufacture.

In accordance with an aspect of the present invention, the use of the pre-shaped current collectors may allow for a thinner current collector to be used, since the design driver of the novel invention is-the maximum stress, and not the maximum deflection. As a result, the pre-shaped current collector will maintain better contact with the MEA, thus minimizing contact resistance between the components.

In a preferred embodiment of the present invention, a curved compression plate may be used to compress the pre-shaped current collectors. The curve can be either an integral part of the plate, or a removable feature.

In another embodiment of the present invention, a substantially flat compression plate may be used to compress the pre-shaped current collectors. The pre-shaped current collectors may maintain their original curvature during compression, alleviating the need for a curved compression plate.

### BRIEF DESCRIPTION OF THE DRAWINGS

The invention description below refers to the accompanying drawings, of which:

FIG. 1A is a cross section of a basic fuel cell prior to a compressed state;

FIG. 1B is a cross section of the fuel cell in a compressed state prior to molding;

FIG. 1C is a cross section of the fuel cell after a frame is created around the compressed assembly;

FIG. 2A is a representative graph of MEA surface pressure during compression;

FIG. 2B is a representative graph of MEA surface pressure relaxation after a frame is molded around the assembly and pre-molding compression is released;

FIG. 3A is a cross section of a basic fuel cell with pre-shaped current collectors prior to a compressed state in accordance with one embodiment of the present invention;

FIG. 3B is a cross section of the fuel cell in a compressed state prior to molding;

FIG. 3C is a cross section of the fuel cell after a frame is created around the compressed assembly;

FIG. 3D is a three-dimensional representation of a pre-shaped current collector that can be used for the present invention;

FIG. 4A is a representative graph of MEA surface pressure during compression using pre-shaped current collectors;

FIG. 4B is a representative graph of MEA surface pressure relaxation after a frame is molded around the assembly using pre-shaped current collectors and pre-molding compression is released;

FIG. 5A is a cross section of a basic fuel cell with pre-shaped current collectors and compression plates prior to a compressed state in accordance with another embodiment of the present invention;

FIG. 5B is a cross section of the fuel cell and compression plates in a compressed state prior to molding;

FIG. 5C is a cross section of the fuel cell and compression plates after a frame is created around the compressed assembly;

FIG. 6A is a cross section of a basic fuel cell with pre-shaped current collectors and flat compression plates prior to a compressed state in accordance with another embodiment of the present invention;

FIG. 6B is a cross section of the fuel cell and compression plates in an intermediary compressed state prior to molding;

FIG. 6C is a cross section of the fuel cell and compression plates in a final compressed state prior to molding;

FIG. 6D is a cross section of the fuel cell and compression plates after a frame is created around the compressed assembly;

### DETAILED DESCRIPTION OF AN ILLUSTRATIVE EMBODIMENT

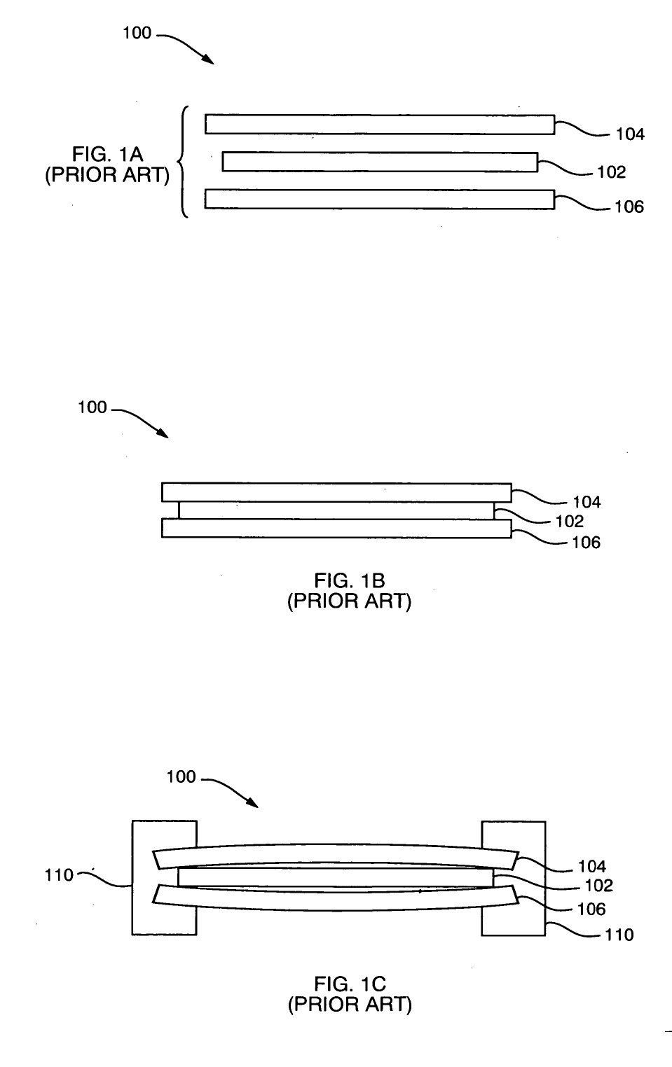

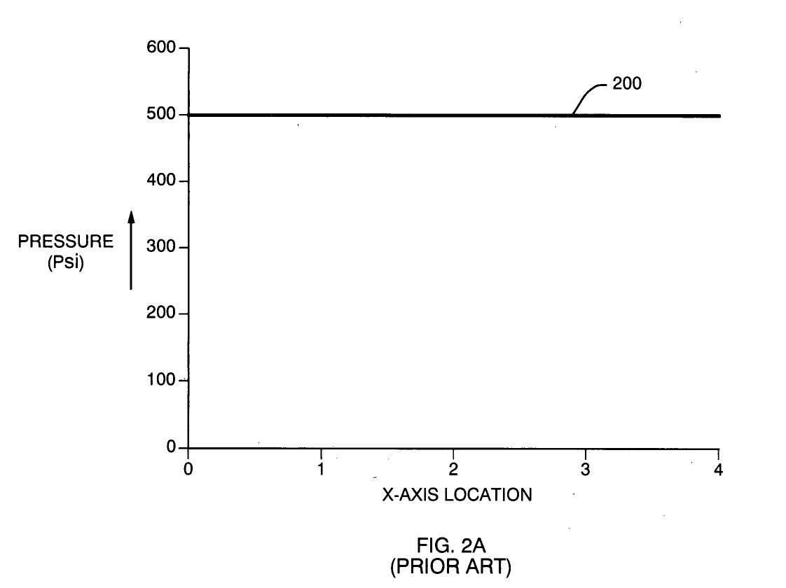

By way of background, FIG. 1A shows a cross section of a basic (prior art) fuel cell 100 prior to a compressed state. A membrane electrode assembly (MEA) 102 is shown between a cathode current collector 104 and an anode current collector 106. Details regarding fuel cell operation can be found in commonly-owned U.S. patent application Ser. No.: 10/413,983, filed on Apr. 15, 2003 by Ren et al. for a DIRECT OXIDATION FUEL CELL WITH PASSIVE WATER MANAGEMENT, which is herein incorporated by reference. Those skilled in the art will recognize that the invention set forth herein can be used with MEAs employing architectures other than those described in the above-mentioned application Ser. No. 10/413,983.

Referring now to FIG. 1B, the cross section of the fuel cell 100 is shown in a compressed state prior to molding. During this state, the multi-layer assembly 100 is in pure compression. The total stiffness k of the assembly 100 is given by the following equation:

$$\frac{1}{k} = \frac{1}{{k}_{A}} + \frac{1}{{k}_{MEA}} + \frac{1}{{k}_{C}}$$

where k_{A} is the stiffness of the anode current collector 106, k_{MEA} is the stiffness of the MEA 102, and k_{C} is the stiffness of the cathode current collector 104. For simplification, because the stiffness k_{MEA} of the MEA 102 is several orders of magnitude smaller than the stiffness k_{A} and k_{C} of the current collectors 104 and 106, the total compressive stiffness k can be approximated by:

$$\frac{1}{k} = \frac{1}{{k}_{MEA}} or , k = {k}_{MEA}$$

The overall deflection δ_{pmc} (distance compressed) of the fuel cell 100 during this pre-molding compression phase is calculated as:

$${δ}_{pmc} = \frac{PA}{k}$$

where P is the surface pressure applied to the fuel cell 100, and A is the surface area of the assembly 100.

Referring now to FIG. 1C, the cross section of the fuel cell 100 is shown after a frame 110 is created around the compressed assembly 100, either by using an injection molding process or other means known to those skilled in the art. Details regarding one method of creation of a frame, such as frame 110, are provided in the above-cited commonly-owned U.S. patent application Ser. No. 10/650,424, which describes the manufacturing of a fuel cell with a molded frame.

After the mold material is injected and the assembly 100 becomes an integrated structure, the surface pressure holding the pre-molding compression is then released. Since the current collectors 104 and 106 are held by the frame 110 at the perimeter, they may bend outwards to a three-dimensional shape that is convex about the two in-plane axes, with the maximum deflection occurring at the approximate center of the current collector, as shown in FIG. 1C. It should be understood that the deflection shown in FIG. 1C is for reference purposes, and not intended to represent a scaled model. It should be understood by those skilled in the art that varying geometries of the current collectors may produce a different deflection than shown here, and that those deflections are still within the scope of protection of the present invention. As a consequence of this deflection that results during prior methods of manufacturing fuel cell assemblies, a portion or in some cases all of the applied pre-molding compression at the center region is relaxed which may result in increased contact resistance of the current collectors 104 and 106 to the MEA 102. A small additional relaxation may also occur at the boundaries of the assembly 100 caused by stretching (or creeping) of the frame 110. The maximum deflection of the current collectors 104 and 106 is the design driver and depends on the current collector geometry and flexural rigidity.

In accordance with the present invention, the deflection is predicted and the current collectors are designed and pre-shaped accordingly. As will be understood by those skilled in the art, the out of plane deflection, w, at a given planar location (xy) is governed by the biharmonic equation shown below where P is again the applied pressure and D is the flexural rigidity of the current collectors 104 and 106:

$$[ \frac{{\partial }^{4}}{\partial {x}^{4}} + \frac{2 {\partial }^{4}}{\partial {x}^{2} \partial {y}^{2}} + \frac{{\partial }^{4}}{\partial {y}^{4}} ] w ( x , y ) = \frac{P}{D}$$

$$D = \frac{{Eh}^{3}}{12 ( 1 - {v}^{2} )}$$

In this equation, h is the thickness of the current collectors 104 and 106, and E and v are the Elastic modulus and Poisson's ratio of the current collector material, respectively. Without limitation of the invention, those skilled in the art will recognize that different values may be used for the current collectors 104 and 106 where additional components are required, or where it is otherwise necessary or desirable to use current collectors with different material characteristics. For the purpose of simplicity, those equations have not been shown here.

The maximum compression reduction can be calculated by the following equation:

$$δ {P}_{max} = \frac{{kw}_{max}}{A}$$

For a current collector of the same material and geometry, the compression reduction is directly proportional to the compressive stiffness k of the assembly.

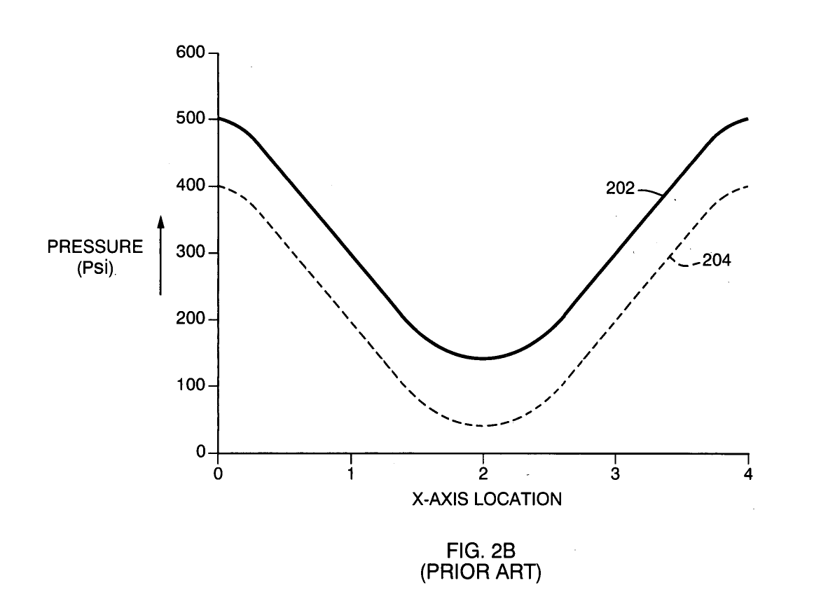

FIGS. 2A-2B are representative graphs of MEA surface pressure during the above-mentioned stages. For simplicity, a two-dimensional graph is shown, corresponding to the two-dimensional fuel cell in FIGS. 1A-1C. It should be understood that in three-dimensions, these graphs will likewise create similar forms in three dimensions. FIG. 2A shows MEA surface pressure 200 during the pre-molding compression stage of a basic fuel cell assembly. A uniform pressure is applied to the surface of the MEA, as shown by the straight line of surface pressure 200.

After a frame is molded around the fuel cell assembly and compression is released, the surface pressure toward the approximate center of the MEA is relaxed. This is due to the fact that the frame only supports the outer edges of the assembly. FIG. 2B shows this MEA surface pressure relaxation 202, which has now become a valley-shaped distribution, with the lowest pressure located at the approximate center of the MEA. This valley corresponds to the outward curvature of the current collector as seen previously in FIG. 1C. Under certain circumstances as described above, the surface pressure after relaxation 202 can further relax over time due to a stretching (or creeping) of the molded frame, resulting in a loss of surface pressure on the MEA, as shown by dotted line 204. 10 Those skilled in the art will recognize that this resultant loss need not be uniform across the surface of the current collector, but has been shown that way in FIG. 2B for illustrative purposes only.

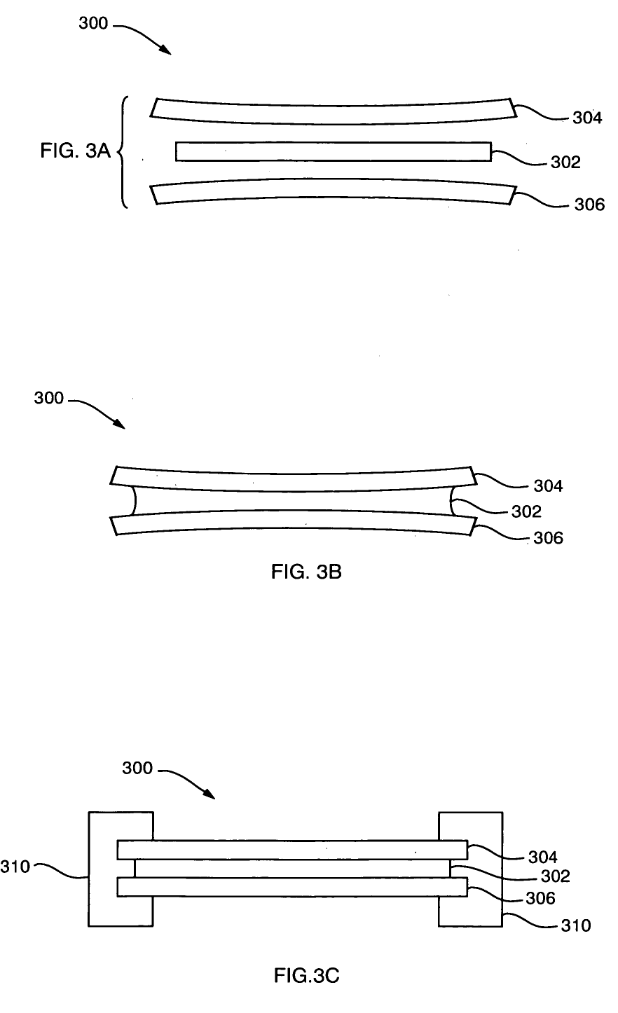

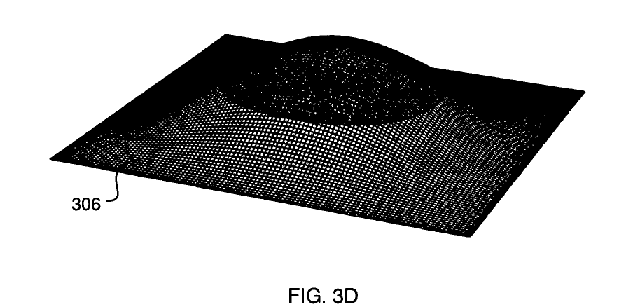

With reference now to FIGS. 3A-3C, one embodiment of the present invention that incorporates the pre-shaped current collectors is shown. FIG. 3A shows a cross section of is a basic fuel cell 300 prior to a compressed state. An MEA 302 is shown between a pre-shaped cathode current collector 304 and a pre-shaped anode current collector 306. Current collectors 304 and 306 are pre-shaped to a convex shape that is substantially the mirror image of its deflection after the surface pressure release. For instance, in the embodiments set forth in FIGS. 3A-3C, the maximum bending depth is applied at the center and is set substantially equal to the resultant deflection of the fuel cell 300 at the center. This pre-shaping helps to counteract the contact resistance that may be created by the deflection of the current collectors once pressure is released. Examples of how this shape can be achieved are by using a multi-step rolling process, etching, machining, electric discharge machining (EDM), or by stamping the material into the desired form. Those skilled in the art will recognize that in some instances it may be desirable to pre-shape the current collector in a manner that differs from the resultant deflection profile in order to remain compatible with other constraints and requirements of the fuel cell system.

As can be seen in FIG. 3B, while under compression, the surface pressure on MEA 302 becomes non-uniform because of the convex shape of the current collectors 304 and 306. The pressure is maximum at the center, and minimum at the perimeter.

In FIG. 3C, after the frame 310 is created and the fuel cell assembly 300 becomes an integrated structure, the surface pressure is released. The pre-shaped current collectors 304 and 306, which are held at the perimeter, still bend outward but the deflection results in a substantially flat current collector that has better contact with the MEA. Consequently, the compression on the MEA 302 becomes substantially uniform across the entire surface of the current collector. This results in an optimally minimum contact resistance of the current collectors 304 and 306 with MEA 302.

For reference, FIG. 3D is a representative, three-dimensional model of a pre-shaped current collector in accordance with an embodiment of the present invention. The pre-shaped current collector 306 shows the maximum deflection at the approximate center of the pre-shaped current collector. A similarly formed current collector could be used as the opposing current collector 304. It should be understood by those skilled in the art that this model is not a scaled model, and is only an example that is not limiting to the scope of the present invention. Other shapes and amplitudes may be suitable under different circumstances, and those variations are within the scope of the present invention.

In this case, the maximum deflection is no longer the design driver, since it is practically eliminated. Instead, the maximum stress (ac) in the current collector material becomes the design driver, and depends on the current collector flexural rigidity and yield strength. The strains at location z (distance from the neutral axis of the plate) can be calculated by the following equations:

$${ɛ}_{xx} = - z \frac{{\partial }^{2} w}{\partial {x}^{2}} {ɛ}_{yy} = - z \frac{{\partial }^{2} w}{\partial {y}^{2}} {ɛ}_{xy} = - z \frac{{\partial }^{2} w}{\partial x \partial y}$$

Then using Hooke's equations one can calculate the stress (σ) as:

$${σ}_{xx} = \frac{E}{1 - {v}^{2}} ( {ɛ}_{xx} + v {ɛ}_{yy} )$$

$${σ}_{yy} = \frac{E}{1 - {v}^{2}} ( {ɛ}_{yy} + v {ɛ}_{xx} )$$

$${σ}_{xy} = \frac{E}{1 + v} {ɛ}_{xy}$$

Because the design driver is the flexural rigidity and yield strength of the current collectors, it is possible to use a thinner current collector in combination with a material that exhibits higher qualities in these aspects. An example of such a material is age-hardenable stainless steel. Using thinner pre-shaped current collectors 304 and 306 results in an overall thinner fuel cell assembly 300, as well as one which is easier to assemble as less compression needs to be applied by the frame. In addition, the invention results in a less expensive current collector, as they can be stamped or etched more economically.

Use of the pre-shaped current collectors 304 and 306 also provides creep tolerance in the fuel cell assembly 300 with an injected molded frame 310. In the case where the frame 310 creeps and further reduces compression, the current collectors 304 and 306 would remain in substantial electrical contact with the MEA 302, because of the curved, spring-like nature of the current collectors.

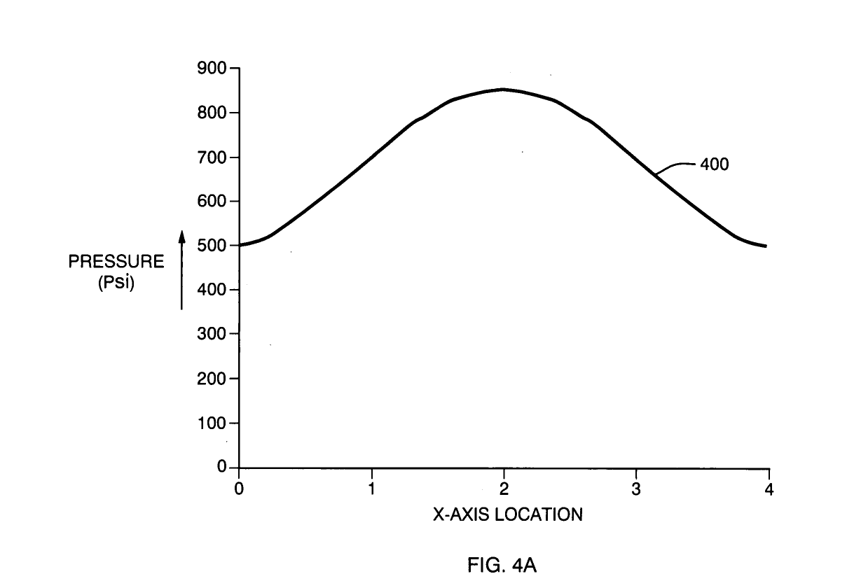

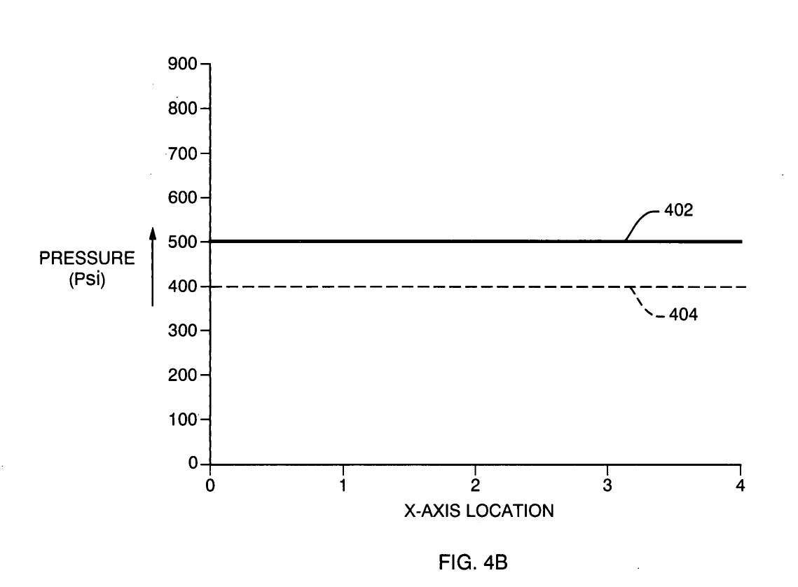

FIGS. 4A-4B are representative graphs of MEA surface pressure during the above-mentioned stages using the pre-shaped current collectors. Again, for simplicity, a two-dimensional graph is shown, corresponding to the two-dimensional fuel cell in FIGS. 3A-3C. It should be understood that in three-dimensions, these graphs will likewise create similar forms in three dimensions. FIG. 4A shows MEA surface pressure 400 during the pre-molding compression stage of a fuel cell assembly in accordance with the present invention. In this case, a non-uniform pressure is applied to the surface of the MEA, as shown by the curved line of surface pressure 400. Those skilled in the art will recognize that this upward-peaking profile is substantially similar, and opposed to, the downward valley of relaxed pressure in FIG. 2B.

Again, after a frame is molded around the fuel cell assembly with the pre-shaped current collectors and compression is released, the surface pressure toward the approximate center of the MEA is relaxed. FIG. 4B shows this MEA surface pressure relaxation 402, which has now become a uniform distribution, with the substantially equal pressure located throughout the surface of the MEA. This straight line corresponds to the linear (planar in three dimensions) nature of the relaxed, pre-shaped current collector as seen previously in FIG. 3C. Still, under certain circumstances as described above, the surface pressure after relaxation 402 can further relax over time due to the stretching (or creeping) of the molded frame, resulting once more in a loss of surface pressure on the MEA, as shown by dotted line 404. This new pressure 404, however, remains higher than the lowest pressure sustained in previous designs as discussed above in FIGS. 1A-2B. Again, those skilled in the art will recognize that this resultant loss need not be uniform across the surface of the current collector, but has been shown that way in FIG. 4B for illustrative purposes only. Those skilled in the art will also recognize that the values shown on the above graphs are for example only, and are in no way limiting to the scope of the present invention.

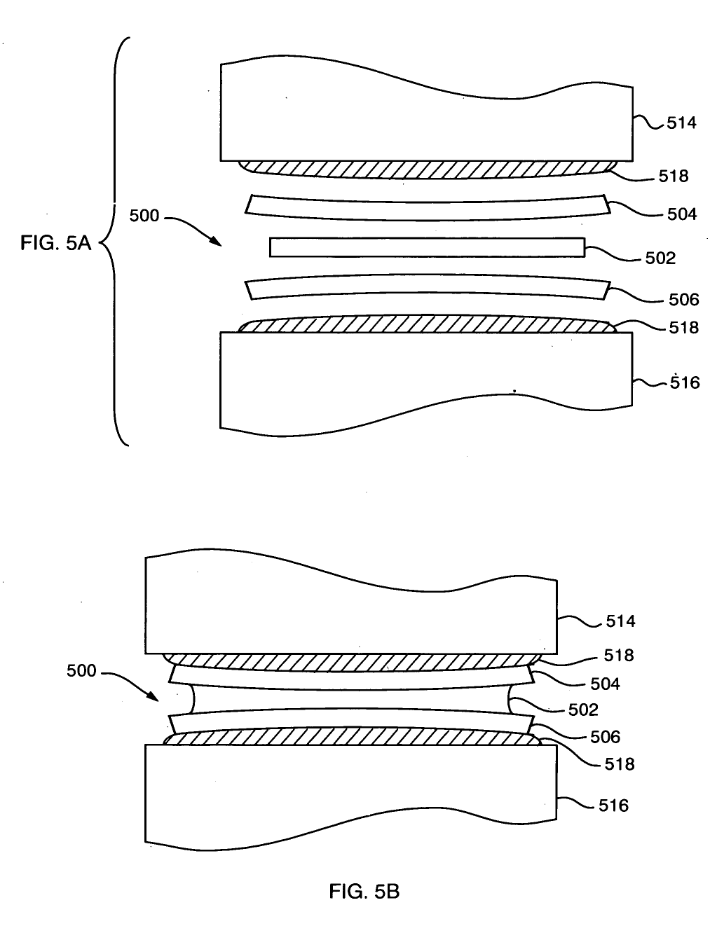

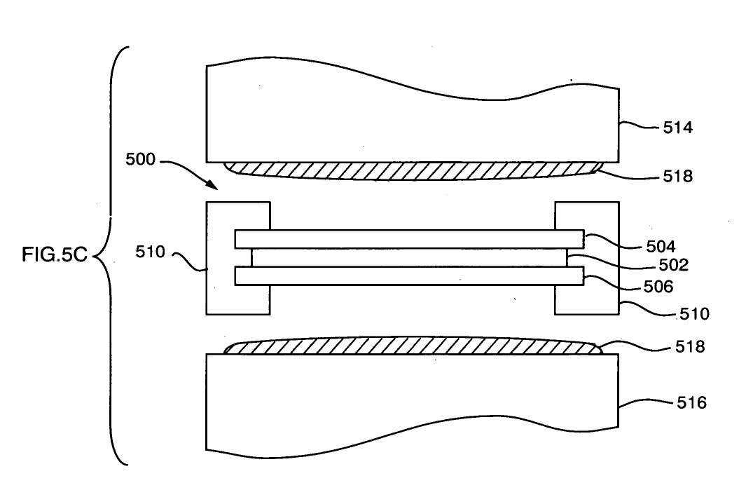

Referring now to FIGS. 5A-5C, compression plates conforming to the pre-shaped current collectors of the present invention are shown. FIG. 5A again shows a cross section of a basic fuel cell 500 prior to a compressed state. The spaces between the components in FIG. 5A are exaggerated for purposes of clarity of illustration. Top compression plate 514 and bottom compression plate 516 are shown having mold plates 518 that correspond to the contour of the pre-shaped current collectors 504 and 506. Mold plates 518 can be an integral part of the compression plates 514 and 516, or a removable feature. FIG. 5B shows the fuel cell assembly 500 and compression plates 514 and 516 in compression in accordance with the present invention, and FIG. 5C shows the completed fuel cell 500 with frame 510.

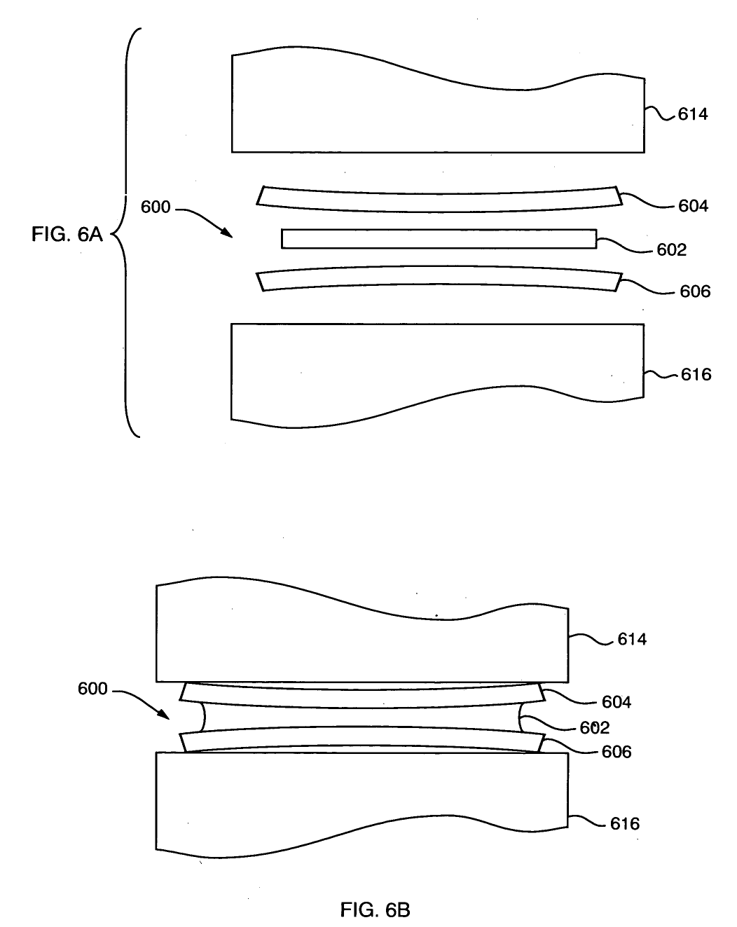

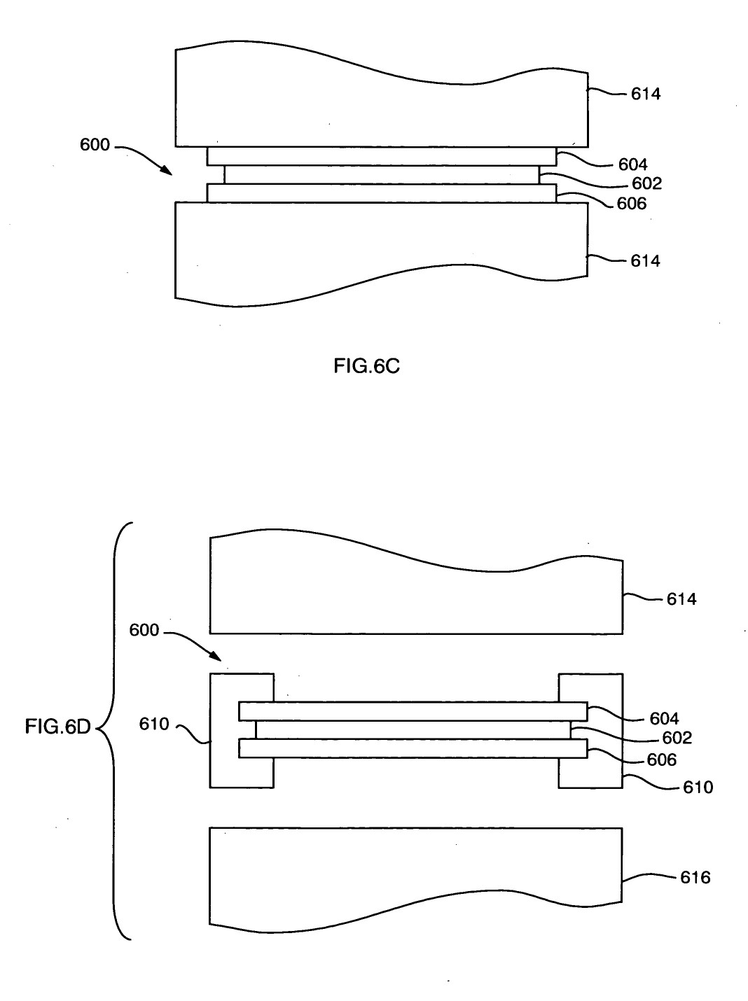

FIGS. 6A-6D show another possible embodiment of the present invention, where substantially flat compression plates 614 and 616 are used with the pre-shaped current collectors 604 and 606 in accordance with the present invention. FIG. 6A illustrates the components with spaces between components again being exaggerated for purposes of illustration. FIG. 6B shows the substantially flat compression plates 614 and 616 at a point of intermediary compression with fuel cell 600. At this point, the curved current collectors 604 and 606 are in non-uniform compression with MEA 602. Continuing the compression process in FIG. 6C, it can be seen that the curvature of the current collectors 604 and 606 flattens out, resulting in a more uniform compression across the surface of MEA 602. Once a frame 610 is created around the perimeter of the fuel cell 600, as seen in FIG. 6D, the deflection of current collectors 604 and 606 has already occurred during the compression, and substantially no further deflection occurs. This is due again to the spring-like nature of the pre-shaped current collectors 604 and 606. A strong current collector material may be suitable for this embodiment.

It should be understood that the present invention is not limited to use with a single fuel cell, but can be used with assemblies comprised of multiple cells, such an assembly of fuel cells arranged in an array. It should also be understood that the present invention is not limited to the number of pre-shaped current collectors used, where it is possible to only have one of the two current collectors be pre-shaped in accordance with the present invention. It is also possible to use only one curved compression plate. It should also be understood that the present invention is not limited to use with a fuel cell assembled using a molded frame, but could be used in other fuel cells that are held together with other methods, such as screws or nuts. Such variations are within the scope of the present invention.

It should be understood that the present invention provides a number of advantages in the fabrication of a fuel cell. The novel pre-shaped current collectors maintain a desired contact resistance of the current collectors and the MEA. This is also the case in the event the frame surrounding the fuel cell stretches or creeps, and in the event that a thinner current collector is used. A level uniformity of fuel cell assembly height and internal compression is also achieved with the use of the pre-shaped current collectors.

The foregoing description has been directed to specific embodiments of the invention. It will be apparent, however, that other variations and other modifications may be made to the described embodiments, with the attainment of some or all of the advantages of such. Therefore, it is the object of the appended claims to cover all such variations and modifications as come with in the true spirit and scope of the invention.

1. A fuel cell comprising:
a first and second current collector, at least one of said first and second current collectors being pre-shaped to counteract contact resistance-inducing deflection; and
a membrane electrode assembly (MEA) sandwiched between said first and second current collectors.

2. The fuel cell as in claim 1, wherein both of said first and second current collectors are pre-shaped.

3. The fuel cell as in claim 1, wherein said pre-shape is a curve that is substantially a mirror image of a predicted resultant current collector deflection.

4. The fuel cell as in claim 1, wherein said pre-shape bends to a substantially flat shape after fuel cell assembly.

5. The fuel cell as in claim 1, wherein said first and second current collectors are conductive.

6. The fuel cell as in claim 1, wherein at least one of said first and second current collectors is a metal.

7. The fuel cell as in claim 1, wherein at least one of said first and second current collectors is an alloy.

8. The fuel cell as in claim 1, wherein at least one of said first and second current collectors is substantially a stainless steel.

9. The fuel cell as in claim 1, wherein at least one of said first and second current collectors is conductively coated.

10. The fuel cell as in claim 1, wherein at least one of said first and second current collectors is coated with a substance that protects said current collector from degradation.

11. The fuel cell as in claim 1, wherein at least one of said first and second current collectors are plated.

12. The fuel cell as in claim 1, wherein said fuel cell is arranged in a substantially planar array of fuel cells.

13. The fuel cell as in claim 12, wherein said array of fuel cells is surrounded by a single frame.

14. The fuel cell as in claim 12, wherein each of said fuel cells within said array is surrounded by a corresponding frame.

15. The fuel cell as in claim 1, further comprising a molded frame surrounding said fuel cell for substantially maintaining compression within said fuel cell.

16. The fuel cell as in claim 1, further comprising a frame surrounding said fuel cell for substantially maintaining compression within said fuel cell, said frame being held in compression using mechanical means.

17. An apparatus for use in manufacturing a fuel cell having a membrane electrode assembly (MEA) and a plurality of current collectors being pre-shaped to counteract contact resistance-inducing deflection, said apparatus comprising:
a first compression plate for receiving said fuel cell;
a second compression plate for compressing said fuel cell into said first compression plate; and
at least one mold plate disposed on one of said first and second compression plates, said mold plate being shaped to substantially conform to the shape of an adjacent one of said plurality of current collectors.

18. The apparatus as in claim 17, wherein both of said first and second compression plates has a mold plate disposed thereon.

19. The apparatus as in claim 17, wherein said shape is a curve that is substantially a mirror image of a predicted resultant current collector deflection.

20. The apparatus as in claim 17, wherein said mold plate is a removable structure.

21. A method for use in manufacture of a fuel cell, said method comprising the steps of:
providing a first and second current collector, at least one of said first and second current collectors being pre-shaped to counteract contact resistance-inducing deflection; and
sandwiching a membrane electrode assembly (MEA) between said first and second current collectors.

22. The method as in claim 21, wherein both of said first and second current collectors are pre-shaped.

23. The method as in claim 21, wherein said pre-shape is a curve that is substantially a mirror image of a predicted resultant current collector deflection.

24. The method as in claim 21, further comprising the step of: compressing said fuel cell between a plurality of compression plates.

25. The method as in claim 24, wherein said plurality of compression plates have a mold plate disposed thereon, said mold plate being shaped to substantially conform to the shape of an adjacent one of said first and second current collectors.

26. The method as in claim 24, further comprising the step of: releasing said compression, thereby allowing each of said pre-shaped first and second current collectors to bend back to a substantially flat orientation.

27. The method as in claim 21, wherein said fuel cell is arranged in a substantially planar array of fuel cells.

28. The method as in claim 21, further comprising the step of: surrounding said fuel cell with a molded frame for substantially maintaining compression within said fuel cell.

29. The method as in claim 21, further comprising the step of: surrounding said fuel cell with a frame for substantially maintaining compression within said fuel cell, said frame being held in compression using mechanical means.

30. A method for use in manufacture of a current collector for use in a fuel cell, said method comprising the steps of:
providing a current collector; and
shaping said current collector in a manner that substantially counteracts contact resistance-inducing deflection.

31. The method as in claim 30, wherein said step of shaping further comprises: etching said current collector into the desired shape.

32. The method as in claim 30, wherein said step of shaping further comprises: rolling said current collector into the desired shape.

33. The method as in claim 30, wherein said step of shaping further comprises: machining said current collector into the desired shape.

34. The method as in claim 30, wherein said step of shaping further comprises: using electric discharge machining (EDM) to machine said current collector into the desired shape.

35. The method as in claim 30, wherein said step of shaping further comprises: stamping said current collector into the desired shape.

36. The method as in claim 30, further comprising the step of: coating said current collector.

37. The method as in claim 30, further comprising the step of: plating said current collector.

38. The method as in claim 30, wherein said shape is a curve that is substantially a mirror image of a predicted resultant current collector deflection.

39. A current collector for use in a fuel cell comprising:
a pre-shaped contour to counteract contact resistance-inducing deflection.

40. The current collector as in claim 39, wherein said pre-shape is a curve that is substantially a mirror image of a predicted resultant current collector deflection.

41. The current collector as in claim 39, wherein said pre-shape is designed to bend to a substantially flat shape after fuel cell assembly.

42. The current collector as in claim 39, wherein said current collector is conductive.

43. The current collector as in claim 39, wherein said current collector is a metal.

44. The current collector as in claim 39, wherein said current collector is an alloy.

45. The current collector as in claim 39, wherein said current collector is substantially a stainless steel.

46. The current collector as in claim 39, wherein said current collector is conductively coated.

47. The current collector as in claim 39, wherein said current collector is coated with a substance that protects said current collector from degradation.

48. The current collector as in claim 39, wherein said current collector is plated.
